(19) United States
(12) Patent Application Publication
(10) Pub. No.: US 2010/0050924 A1
(43) Pub. Date: Mar. 4, 2010

(54) METHOD FOR PROVIDING A FOULING PREVENTING COATING

(76) Inventor: Kjell K. Alm, Athens (GR)

Correspondence Address: HARNESS, DICKEY & PIERCE, P.L.C., P.O. BOX 8910, RESTON, VA, 20195, US

(21) Appl. No.: 12/449,851

(22) PCT Filed: Feb. 14, 2008
(86) PCT No.: PCT/EP2008/051783

§ 371 Date: Oct. 7, 2009

(30) Foreign Application Priority Data
Mar. 2, 2007 (EP) 07103366.6

(51) Int. Cl. B63B 59/04; B29C 65/52; B32B 37/00

(52) U.S. Cl. 114/65 R; 156/276

(57) ABSTRACT

In one embodiment of the present invention, a method for providing a fouling preventing coating, including pile fabric sheets, on a marine structure surface, includes applying a binder layer on the surface. The method further includes adhering the sheets to the binder layer in an non-overlapping way, creating the fouling preventing coating, and filling interspaces in the coating between the adhered sheets by adhering fibres to the binder layer in the interspaces.

### TECHNICAL FIELD OF THE INVENTION

The present invention relates to anti-fouling coatings on marine vessels and structures which are wholly or partially under the surface of water. More specifically the invention concerns a method for providing a fouling preventing coating, comprising pile fabric sheets, on a marine structure surface.

### BACKGROUND ART

Providing vessels and other marine structures with pile or fur material or fibre flocked sheets on surfaces under the water line will prevent growth of algae and other plants and animals on the surfaces, i.e. the sheets have an fouling preventing effect. Coating the surfaces with toxic substances hence becomes unnecessary.

In EP 353 095 is showed fur coated sheets attached on the parts to be protected. The sheets have fibres with a length of preferably 10-30 mm in order to sway freely in the water. GB 2 221 428 describes a ribbon planting method, comprising slitting of a film into long ribbons, folding or undulation of the long ribbons on a substrate, wherein said ribbons have a thickness of between 5 and 25 μm, a width of between 1 and 10 mm and a length of between 10 and 100 mm. From EP 312 600 is known a pile material, which is attached to that part of a ship which is submerged in water, and thus prevent attachment of organisms thereto.

All of these documents mentions the possibility to use a binder for attaching the sheets or other types of material to the surface. These documents generally describe attaching of the sheets but do not describe how to avoid interspaces in the coating formed by the sheets. To cover a curved form, such as the hull of a boat, with a planar, essentially unelastic sheet without any gaps between the sheets implies time- and material-demanding cutting of the sheets to the curved form. On the other hand it is important that there are no gaps as they would create weak spots on the surface.

### SUMMARY OF THE INVENTION

The object of the invention is to eliminate this drawback and to improve and facilitate the method for providing a fouling preventing coating on a marine structure surface without discontinuities in the fouling preventing coating.

This object is achieved by means of a method according the in the introduction mentioned method, which comprises applying a binder layer on the surface, adhering the sheets to the binder layer in an non-overlapping way, creating the fouling preventing coating, and filling interspaces in the coating between the adhered sheets by adhering fibres to the binder layer in the interspaces.

A convenient and efficient way of applying the fibres is spraying by means of an electrostatic technology on the surface.

### DETAILED DESCRIPTION OF A PREFERRED EMBODIMENT OF THE INVENTION

Below will be described a preferred embodiment of the method according the invention for providing a fouling preventing coating on a marine structure surface. The invention is not limited to this embodiment but can be varied in different ways within the scope of the claims.

The marine structure is a vessel or boat and the surface is hence the hull of the boat, but could of course also be other structures, such as underwater pipes.

For fouling preventing the hull is covered with a pile fabric, which is flexible but unelastic. An example of a pile fabric is a fibre flocked sheet, made by applying a binder on the sheet and the spraying the sheet with electrically charged fibres, which then attach to the sheet. The sheet is covered with 50-300 fibres/mm², wherein the fibres have a length of 0.7-3 mm and a fibre linear density of 1-20 denier. This fiber flocking technique is a well known technique for applying fibres on fabrics and other surfaces. The sheet is cut to appropriate lengths depending on the application. This is done indoors under controlled circumstances, i.e not disturbed by weather factors, such as wind or rain.

A binder is applied to that part of the hull which is to be under water.

Thereafter the lengths of fibre sheet are attached to the binder in a non-overlapping way. This creates interspaces having a size of approximatively 0-50 mm between the lengths.

Before the binder has dried fibres are sprayed on the gaps in an amount of 50-300 fibres/mm². The fibres, having a length of 0.7-3 mm and a fibre linear density of 1-20 denier, are preferably of the same kind and the same size as the fibres used for the fibre flocked sheets.

The application of the fibres in the gaps is done by spraying with electrically charged fibres. One way of doing this is by blowing fibres through a plastic tube, wherein the fibres get frictionally charged.

The binder is preferably a two component resin and the fibres used are synthetic fibres made of, for example, polyamide, but also coal fibres, glass fibres or similar can be used.

1. Method for providing a fouling preventing coating, comprising pile fabric sheets, on a marine structure surface, which method comprises
applying a binder layer on the surface,
adhering the sheets to the binder layer in an non-overlapping way, creating the fouling preventing coating, and
filling interspaces in the coating between the adhered sheets by adhering fibres to the binder layer in the interspaces.

2. Method according to claim 1, comprising spraying fibres in the interspaces

3. Method according to claim 1, comprising applying fibres with an electrostatic technology.

4. Hull of a marine structure provided with fields of pile fabric sheets and with interspaces between the fields covered with fibres.

5. Method according to claim 2, comprising applying fibres with an electrostatic technology.
